(19) United States
(12) Patent Application Publication
(10) Pub. No.: US 2022/0251411 A1
(43) Pub. Date: Aug. 11, 2022

(54) METHODS FOR RESISTING FROST ON A SUBSTRATE, COMPOSITIONS, AND COPOLYMERS USEFUL THEREFOR

(71) Applicant: RHODIA OPERATIONS, Aubervilliers (FR)

(72) Inventors: Congyu BAO, Shanghi (CN); Pengfei JI, Shanghi (CN); Yunjiao GU, Shanghi (CN)

(21) Appl. No.: 17/619,422

(22) PCT Filed: Jul. 9, 2019
(86) PCT No.: PCT/CN2019/095231

§ 371 Date: Dec. 15, 2021

(51) Int. Cl. C09D 133/14

(52) U.S. Cl. CPC C09D 133/14

(57) ABSTRACT

The present disclosure relates to use of a composition for making frost resistant a substrate, the composition comprising a copolymer having repeating units derived from one or more zwitterionic monomers and repeating units derived from one or more phosphorous acid monomers.

### FIELD OF THE INVENTION

The present invention relates to the field of resisting frost on a substrate, compositions, and copolymers useful therefor.

### BACKGROUND

Frosting happens when the surface temperature is below both water freezing temperature and air dew point temperature. In other words, the frost starts to form when the contact happens between the cold surface and the near water vapor in the air due to the temperature difference. Frosting is a common natural phenomenon on cold surface. In our daily life, frosting on cold surface will lower the operating efficiency of refrigerating equipment and cause huge energy waste, for example: the frosting of heat exchangers of air conditionings, the frosting of refrigerators and other refrigerating plants. As a frost layer has certain thermal isolating effect, the frost on the surface of refrigerating equipment will impair the heat transfer efficiency of the equipment and narrow or even block the airflow channel, thereby resulting in huge energy waste.

Current anti-frosting surface modification technologies proceed in two general directions: superhydrophobic and polymeric hydrophilic coatings. Superhydrophobic coating, typically nanocomposite coatings usually suffers durability problem. Therefore, it is still technically challenging for the industry to produce superhydrophobic coatings with long-lasting frost-resisting performance. Polymeric hydrophilic coating, typically containing hydroxyl acrylates, is the priority for the industry now, due to its facile fabrication process and easy access to such hydrophilic resins, but with unsatisfied frost-resisting performance.

Recently, He et al. Sci. Adv. 2016 reports the effect of ions on Heterogeneous Ice Nucleation (HIN) on the polyelectrolyte brush (PB) surface. The PB consists of densely end-grafted polyelectrolyte chains, carrying a large number of ionic groups. Specifically, cationic poly[2-(methacryloyloxy)-ethyltrimethylammonium](PMETA) and anionic poly(3-sulfopropyl methacrylate) (PSPMA) brushes on gold surface were used to study the effect of diffused counterions on tuning HIN. However, the anti-frosting performance is not mentioned.

Thus, there is an ongoing need for new or improved methods and compositions for resisting frost.

### SUMMARY OF THE INVENTION

In a first aspect, the present disclosure relates to a method for making frost resistant a substrate in need thereof, the method comprising at least partially applying to the substrate, in an amount effective to make it frost resistant, a composition comprising a copolymer having repeating units derived from one or more zwitterionic monomers, typically one or more betaine monomers, and repeating units derived from one or more phosphorous acid monomers; thereby making the substrate frost resistant.

In a second aspect, the present disclosure relates to use of a composition for making frost resistant a substrate, the composition comprising a copolymer having repeating units derived from one or more zwitterionic monomers, typically one or more betaine monomers, and repeating units derived from one or more phosphorous acid monomers.

### BRIEF DESCRIPTION OF DRAWINGS

FIG. 1 is a picture of the facility employed to measure heat exchange capacity (Q).

### DETAILED DESCRIPTION

As used herein, the terms “a”, “an”, or “the” means “one or more” or “at least one” unless otherwise stated.

As used herein, the term “comprises” includes “consists essentially of” and “consists of.” The term “comprising” includes “consisting essentially of” and “consisting of.”

Throughout the present disclosure, various publications may be incorporated by reference. Should the meaning of any language in such publications incorporated by reference conflict with the meaning of the language of the present disclosure, the meaning of the language of the present disclosure shall take precedence, unless otherwise indicated.

The present disclosure relates to a method for making frost resistant a substrate in need thereof, the method comprising at least partially applying to the substrate a composition comprising a copolymer having repeating units derived from one or more zwitterionic monomers, typically one or more betaine monomers, and repeating units derived from one or more phosphorous acid monomers in an amount effective to resist frost on the substrate.

In accordance with the present disclosure, resisting the frost refers to partial or complete inhibition of the frost on a surface. Resistance also includes slowing down frosting on a surface.

Without wishing to be bound to theory, the formation of frost is believed to be resisted by the disrupted water crystallization on charged surfaces. Frosting, occurred on foreign hygroscopic surfaces, is described as heterogeneous ice nucleation (HIN). HIN on charged surfaces is believed to be affected by the interfacial water structure, and is also dependent on the amount of surface charges. For instance, the orientational relaxation of interfacial water molecules decays more slowly with the increase of the anion charge density, and the hydrogen bond making rate of ice-like water molecules increases in the order of F⁻<Cl⁻<I⁻.

The method described herein makes use of a composition comprising a copolymer having repeating units derived from one or more zwitterionic monomers, typically one or more betaine monomers, and repeating units derived from one or more phosphorous acid monomers.

The step of at least partially applying to the substrate the composition comprising a copolymer having repeating units derived from one or more zwitterionic monomers, typically one or more betaine monomers, and repeating units derived from one or more phosphorous acid monomers described herein may be achieved using any method known to those of ordinary skill in the art. For example, the composition may be applied by spray coating, spin coating, gravure coating, curtain coating, dip coating, slot-die coating, rod or bar coating, doctor-blade coating, flowcoating, which involves controlled gravity flow of a coating over the substrate, or the like. Further examples include applying the composition onto a woven or nonwoven article and then contacting the woven or nonwoven article on the surface to be applied.

The pH of the composition is not particularly limited. Typically, the pH of the composition is from 6 to 8.

The copolymer of the present disclosure comprises repeating units derived from one or more zwitterionic monomers, typically one or more betaine monomers, and repeating units derived from one or more phosphorous acid monomers.

In an embodiment, the copolymer is a block copolymer, branched copolymer, or statistical copolymer.

In another embodiment, the copolymer is a statistical copolymer.

Unless otherwise indicated, when molar mass is referred to, the reference will be to the weight-average molar mass, expressed in g/mol. The latter can be determined by aqueous gel permeation chromatography (GPC) with light scattering detection (DLS or alternatively MALLS), with an aqueous eluent or an organic eluent (for example dimethylacetamide, dimethylformamide, and the like), depending on the copolymer. There is no particular limitation to the molar mass of the copolymer. However, the weight-average molar mass (Mw) of the copolymer is in the range of from about 5,000 to about 3,000,000 g/mol, typically from about 8000 to about 1,000,000, g/mol, more typically from about 10,000 to 500,000 g/mol, even more typically 20,000 to 200,000 g/mol.

The copolymer of the present disclosure comprises repeating units derived from one or more zwitterionic monomers. As used herein, zwitterionic monomers refer to monomers capable of polymerization that are neutral in overall charge but contain a number of cationic (positive) charges equal to the number of anionic (negative charges). The cationic charge(s) may be contributed by one or more onium or inium cations of nitrogen, such as ammonium, pyridinium and imidazolinium cations; phosphorus, such as phosphonium; and/or sulfur, such as sulfonium. The anionic charge(s) may be contributed by one or more carbonate, sulfonate, phosphate, phosphonate, phosphinate or ethenolate anions, and the like. Suitable zwitterionic monomers include, but are not limited to, betaine monomers, which are zwitterionic and comprise an onium atom that bears no hydrogen atoms and that is not adjacent to the anionic atom.

In an embodiment, the repeating units derived from one or more zwitterionic monomers are repeating units derived from one or more betaine monomers selected from the group consisting of:

a) alkyl sulfonates or phosphonates of dialkylammonium alkyl acrylates or methacrylates, acrylamido or methacrylamido, typically
sulfopropyldimethylammonioethyl methacrylate,
sulfoethyldimethylammonioethyl methacrylate,
sulfobutyldimethylammonioethyl methacrylate,
sulfohydroxypropyldimethylammonioethyl methacrylate,
sulfopropyldimethylammoniopropylacrylamide,
sulfopropyldimethylammoniopropylmethacrylamide,
sulfohydroxypropyldimethylammoniopropyl(meth)acrylamide,
sulfopropyldiethylammonioethyl methacrylate;
   b) heterocyclic betaine monomers, typically
sulfobetaines derived from piperazine,
sulfobetaines derived from 2-vinylpyridine and 4-vinylpyridine, more typically 2-vinyl-1-(3-sulfopropyl)pyridinium betaine or 4-vinyl-1-(3-sulfopropyl)pyridinium betaine,
1vinyl-3-(3-sulfopropyl)imidazolium betaine;
   c) alkyl or hydroxyalkyl sulfonates or phosphonates of dialkylammonium alkyl allylics, typically sulfopropylmethyldiallylammonium betaine;
   d) alkyl or hydroxyalkyl sulfonates or phosphonates of dialkylammonium alkyl styrenes;
   e) betaines resulting from ethylenically unsaturated anhydrides and dienes;
   f) phosphobetaines of formulae

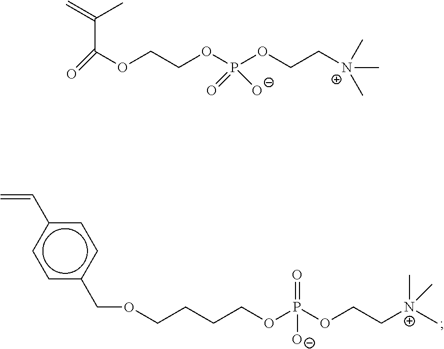

and
g) betaines resulting from cyclic acetals, typically ((dicyanoethanolate)ethoxy)dimethylammoniopropylmethacrylamide.

In another embodiment, the repeating units derived from one or more zwitterionic monomers are repeating units derived from one or more betaine monomers selected from the group consisting of:
sulfopropyldimethylammonioethyl (meth)acrylate,
sulfoethyldimethylammonioethyl (meth)acrylate,
sulfobutyldimethylammonioethyl (meth)acrylate,
sulfohydroxypropyldimethylammonioethyl (meth)acrylate,
sulfopropyldimethylammoniopropylacrylamide,
sulfopropyldimethylammoniopropylmethacrylamide,
sulfohydroxypropyldimethylammoniopropyl(meth)acrylamide, and
sulfopropyldiethylammonioethyl methacrylate.

Still in another embodiment, the repeating units derived from one or more zwitterionic monomers are repeating units derived from one or more betaine monomers selected from the group consisting of: sulfohydroxypropyldimethylammonioethyl (meth)acrylamide and sulfopropyldimethylammonioethyl (meth)acrylate.

The copolymer of the present disclosure also comprises repeating units derived from one or more phosphorous acid monomers. As used herein, phosphorous acid monomers refer to any phosphorus-containing oxyacid monomer capable of being polymerized. Phosphorous acid monomers capable of being polymerized include monomers derived from phosphoric acid, phosphonic acid, or phosphinic acid (also known as hypophosphorous acid) in which at least one of the hydrogen atoms, which may be attached to phosphorus or oxygen, has been replaced with a double bond-containing organic group, typically acryl, acryloxy, methacryl, methacryloxy, styryl, allyl, or vinyl group. The phosphorous acid monomers may be in the acid form or as a salt of the phosphorous acid groups.

In an embodiment, the repeating units derived from one or more phosphorous acid monomers are repeating units derived from:

a) phosphoric acid monomers in which at least one of the hydrogen atoms has been replaced with a double bond-containing organic group; typically
those selected from the group consisting of dihydrogenphosphate esters of an alcohol in which the alcohol comprises a polymerizable vinyl or olefinic group, more typically allyl phosphate, vinyl phosphate, mono- or diphosphate of bis(hydroxy-methyl) fumarate or itaconate; derivatives of (meth)acrylic acid esters, typically phosphates of hydroxyalkyl(meth)acrylates, more typically 2-hydroxyethyl (meth)acrylate, and 3-hydroxypropyl (meth)acrylates;
   b) phosphonic acid monomers in which at least one of the hydrogen atoms has been replaced with a double bond-containing organic group; typically
those selected from the group consisting of vinyl phosphonic acid, allyl phosphonic acid, 2-acrylamido-2-methylpropanephosphonic acid, α-phosphonostyrene, 2-methylacrylamido-2-methylpropanephosphonic acid, and ((diallylamino)methyl)phosphonic acid;
   c) phosphinic acid monomers in which at least one of the hydrogen atoms has been replaced with a double bond-containing organic group; typically
1,2-ethylenically unsaturated (hydroxy)phosphinylalkyl (meth)acrylate monomers, more typically (hydroxy)phosphinylmethyl methacrylate.

In an embodiment, the repeating units derived from one or more phosphorous acid monomers are repeating units derived from phosphonic acid monomers in which at least one of the hydrogen atoms has been replaced with a double bond-containing organic group.

In an embodiment, the repeating units derived from one or more phosphorous acid monomers are repeating units derived from vinyl phosphonic acid.

In another embodiment, the repeating unit derived from one or more zwitterionic monomers are repeating units derived from sulfopropyldimethylammonioethyl methacrylate (SPE) and the repeating units derived from one or more phosphorous acid monomers are repeating units derived from vinyl phosphonic acid (VPA).

Still in another embodiment, the repeating unit derived from one or more zwitterionic monomers are repeating units derived from sulfohydroxypropyldimethylammoniopropylacrylam ide (AHPS) and the repeating units derived from one or more phosphorous acid monomers are repeating units derived from vinyl phosphonic acid (VPA).

The copolymer comprises up to 90 mol %, typically less than 70 mol %, more typically less than 50 mol % and even more typically less than 30 mol % of repeating units derived from phosphorous acid monomers, based on the molar composition of the copolymer. In an embodiment, the copolymer comprises about 1 mol % to about 20 mol %, typically about 5 mol % to about 10 mol % of repeating units derived from phosphorous acid monomers, based on the molar composition of the copolymer.

In an embodiment, the copolymer comprises up to 90 mol %, typically less than 70 mol %, more typically less than 50 mol % and even more typically less than 30 mol % of repeating units derived from vinyl phosphonic acid, based on the molar composition of the copolymer. In an embodiment, the copolymer comprises about 1 mol % to about 20 mol %, typically about 5 mol % to about 10 mol % of repeating units derived from vinyl phosphonic acid, based on the molar composition of the copolymer.

The copolymer comprises greater than 30 mol %, typically greater than 50 mol %, more typically greater than 70 mol %, even more typically greater than 90 mol %, of repeating units derived from the one or more zwitterionic monomers, based on the molar composition of the copolymer. In an embodiment, the copolymer comprises about 80 mol % to about 99 mol %, typically about 90 mol % to about 95 mol % of repeating units derived from the one or more zwitterionic monomers, based on the molar composition of the copolymer.

In some embodiments, the copolymer of the present disclosure comprises, in addition to repeating units derived from zwitterionic monomers and repeating units derived from phosphorous acid monomers, repeating units derived from other monomers. Generally, the other monomers are selected from (meth)acrylates and (meth)acrylamides.

Preferably, the other monomers are selected from the list consisting of 2-hydroxyethyl methacrylate (HEMA), hydroxypropyl methacrylate, 2-hydroxyethyl acrylate (HEA), hydroxypropyl acrylate, 4-hydroxybutyl acrylate, poly(ethylene glycol) methacrylate (PEGMA), poly(ethylene glycol) methyl ether methacrylate, poly(ethylene glycol) ethyl ether methacrylate, poly(ethylene glycol) methyl ether acrylate and poly(ethylene glycol) ethyl ether acrylate. Good results were obtained with 2-hydroxyethyl methacrylate (HEMA) and 2-hydroxyethyl acrylate (HEA).

In some embodiments, the copolymer of the present disclosure comprises repeating units derived from sulfopropyldimethylammonioethyl methacrylate (SPE), repeating units derived from vinyl phosphonic acid (VPA) and repeating units derived from monomers selected from the list consisting of HEMA, HEA and poly(ethylene glycol) methyl ether methacrylate (mPEGMA).

In some other embodiments, the copolymer of the present disclosure comprises repeating units derived from sulfohydroxypropyldimethylammoniopropylacrylam ide (AHPS), repeating units derived from vinyl phosphonic acid (VPA) and repeating units derived from monomers selected from the list consisting of HEMA, HEA and poly(ethylene glycol) methyl ether methacrylate (mPEGMA).

When, the copolymer of the present disclosure comprises, in addition to repeating units derived from zwitterionic monomers and repeating units derived from phosphorous acid monomers, repeating units derived from other monomers, the copolymer comprises about 1 mol % to about 20 mol %, typically about 3 mol % to about 15 mol % and more typically about 5 mol % to about 10 mol % of repeating units derived from phosphorous acid monomers, based on the molar composition of the copolymer. Besides, the copolymer comprises about 80 mol % to about 99 mol %, typically about 90 mol % to about 95 mol % of repeating units derived from the one or more zwitterionic monomers and from the other monomers, based on the molar composition of the copolymer. The molar ratio of repeating units derived from the one or more zwitterionic monomers with repeating units derived from the other monomers ranges typically from 0.25 to 4, more typically from 0.5 to 2.

The copolymer of the present disclosure may be obtained by any polymerization process known to those of ordinary skill. For example, the copolymer may be obtained by radical polymerization or copolymerization or controlled radical polymerization in aqueous solution, in dispersed media of zwitterionic monomers, typically betaine monomers, containing at least one double bond-containing group with phosphorous acid monomers in which at least one of the hydrogen atoms has been replaced with a double bond-containing organic group. The zwitterionic monomers and phosphorous acid monomers may be obtained from commercial sources or synthesized according to methods known to those of ordinary skill in the art.

Suitable zwitterionic monomers include, but are not limited to, betaine monomers selected from the group consisting of:

a) alkyl or hydroxyalkyl sulfonates or phosphonates of dialkylammonium alkyl acrylates or methacrylates, acrylamido or methacrylamido, typically:
sulfopropyldimethylammonioethyl methacrylate, sold by Raschig under the name SPE:

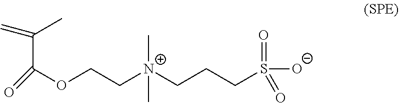 [SMILES: C=C(C)C(=O)OCC[N+](C)(C)CCCS(=O)(=O)[O-]]

sulfoethyldimethylammonioethyl methacrylate,

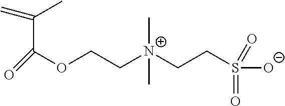 [SMILES: C=C(C)C(=O)OCC[N+](C)(C)CCS(=O)(=O)[O-]]

sulfobutyldimethylammonioethyl methacrylate:

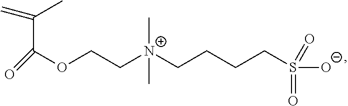 [SMILES: C=C(C)C(=O)OCC[N+](C)(C)CCCCS(=O)(=O)[O-]]

the synthesis of which is described in the paper “Sulfobetaine zwitterionomers based on n-butyl acrylate and 2-ethoxyethyl acrylate: monomer synthesis and copolymerization behavior”, Journal of Polymer Science, 40, 511-523 (2002),
sulfohydroxypropyldimethylammonioethyl methacrylate,

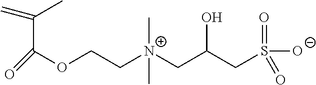 [SMILES: C=C(C)C(=O)OCC[N+](C)(C)CC(O)CS(=O)(=O)[O-]]

sulfopropyldimethylammoniopropylacrylamide,
   the synthesis of which is described in the paper “Synthesis and solubility of the poly(sulfobetaine)s and the corresponding cationic polymers: 1. Synthesis and characterization of sulfobetaines and the corresponding cationic monomers by nuclear magnetic resonance spectra”, Wen-Fu Lee and Chan-Chang Tsai, Polymer, 35 (10), 2210-2217 (1994),
sulfopropyldimethylammoniopropylmethacrylamide, sold by Raschig under the name SPP:

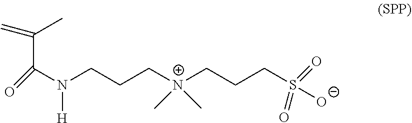 [SMILES: C=C(C)C(=O)NCCC[N+](C)(C)CCCS(=O)(=O)[O-]]

sulfohydroxypropyldimethylammoniopropylmethacrylamide:

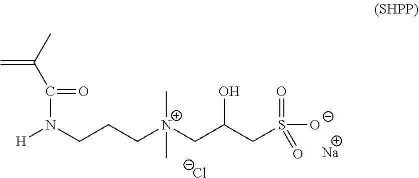 [SMILES: C=C(C)C(=O)NCCC[N+](C)(C)CC(O)CS(=O)(=O)[O-] ; [Na+] ; [Cl-]]

sulfohydroxypropyldimethylammoniopropylacrylam ide (or 3-((3-acrylamidopropyl)dimethylammonio)-2-hydroxypropane-1-sulfonate):

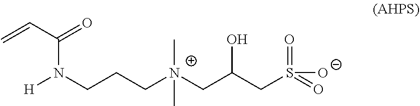 [SMILES: C=CC(=O)NCCC[N+](C)(C)CC(O)CS(=O)(=O)[O-]]

sulfopropyldiethylammonio ethoxyethyl methacrylate:

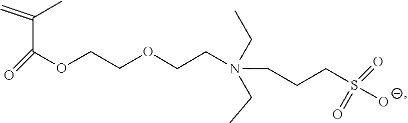

the synthesis of which is described in the paper “Poly(sulphopropylbetaines): 1. Synthesis and characterization”, V. M. Monroy Soto and J. C. Galin, Polymer, 1984, Vol. 25, 121-128;
b) heterocyclic betaine monomers, typically:
sulfobetaines derived from piperazine having any one of the following structures

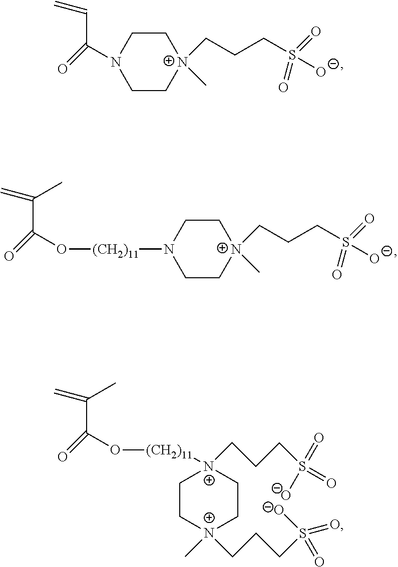

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
sulfobetaines derived from 2-vinylpyridine and 4vinylpyridine, such as 2-vinyl-1-(3-sulfopropyl)pyridinium betaine (2SPV), sold by Raschig under the name SPV:

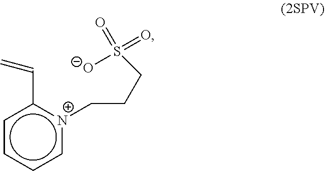

and 4-vinyl-1-(3-sulfopropyl)pyridinium betaine (4SPV),

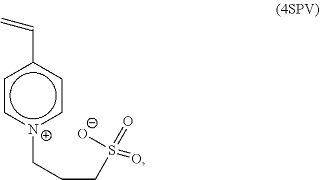

the synthesis of which is disclosed in the paper “Evidence of ionic aggregates in some ampholytic polymers by transmission electron microscopy”, V. M. Castaño and A. E. González, J. Cardoso, O. Manero and V. M. Monroy, J. Mater. Res., 5 (3), 654-657 (1990),
1-vinyl-3-(3-sulfopropyl)imidazolium betaine:

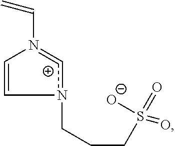

the synthesis of which is described in the paper “Aqueous solution properties of a poly(vinyl imidazolium sulphobetaine)”, J. C. Salamone, W. Volkson, A. P. Dison, S. C. Israel, Polymer, 19, 1157-1162 (1978),
c) alkyl or hydroxyalkyl sulfonates or phosphonates of dialkylammonium alkyl allylics, typically sulfopropylmethyldiallylammonium betaine:

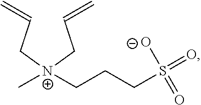

the synthesis of which is described in the paper “New poly(carbobetaine)s made from zwitterionic diallylammonium monomers”, Favresse, Philippe; Laschewsky, Andre, Macromolecular Chemistry and Physics, 200(4), 887-895 (1999),
d) alkyl or hydroxyalkyl sulfonates or phosphonates of dialkylammonium alkyl styrenes, typically compounds having any one of the following structures:

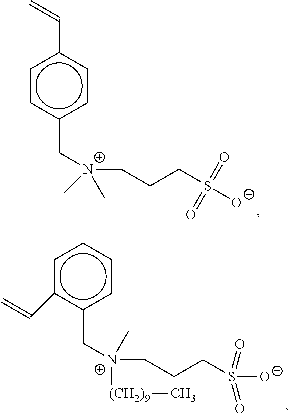

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
e) betaines resulting from ethylenically unsaturated anhydrides and dienes, typically compounds having any one of the following structures:

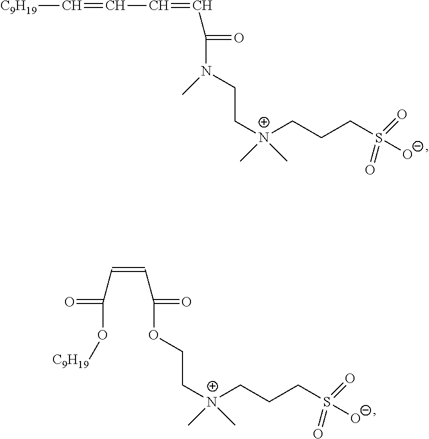

the synthesis of which is described in the paper “Hydrophobically Modified Zwitterionic Polymers: Synthesis, Bulk Properties, and Miscibility with Inorganic Salts”, P. Koberle and A. Laschewsky, Macromolecules, 27, 2165-2173 (1994),
f) phosphobetaines having any one of the following structures:

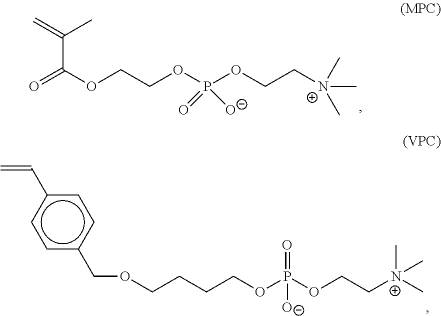

the synthesis of which are disclosed in EP 810 239 B1 (Biocompatibles, Alister et al.);
g) betaines resulting from cyclic acetals, typically ((dicyanoethanolate)ethoxy)dimethylammoniumpropylmethacrylamide:

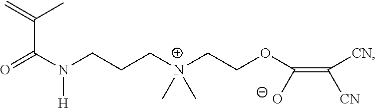 [SMILES: C=C(C)C(=O)NCCC[N+](C)(C)CCOC([O-])=C(C#N)C#N]

the synthesis of which is described by M-L. Pujol-Fortin et al. in the paper entitled “Poly(ammonium alkoxydicyanatoethenolates) as new hydrophobic and highly dipolar poly(zwitterions). 1. Synthesis”, Macromolecules, 24, 4523-4530 (1991).

In another embodiment, one or more zwitterionic monomers are one or more betaine monomers selected from the group consisting of:
sulfopropyldimethylammonioethyl methacrylate,
sulfoethyldimethylammonioethyl methacrylate,
sulfobutyldimethylammonioethyl methacrylate,
sulfohydroxypropyldimethylammonioethyl methacrylate,
sulfopropyldimethylammoniopropylacrylamide,
sulfopropyldimethylammoniopropylmethacrylamide,
sulfohydroxypropyldimethylammoniopropyl(meth)acrylamide, and
sulfopropyldiethylammonioethyl methacrylate.

In an exemplary method, the copolymer is obtained by radical polymerization or copolymerization using a radical initiator, such as 2,2′-azobis(2-methylbutyronitrile).

The copolymer of the present disclosure may also be obtained by chemical modification of a polymer referred to as a precursor polymer. For example, a copolymer comprising repeating units derived from sulfobetaine may be obtained by chemical modification of a polymer comprising pendent amine functional groups with a sultone, such as propane sultone or butane sultone, a haloalkylsulfonate or any other sulfonated electrophilic compound known to those of ordinary skill in the art. Exemplary synthetic steps are shown below:

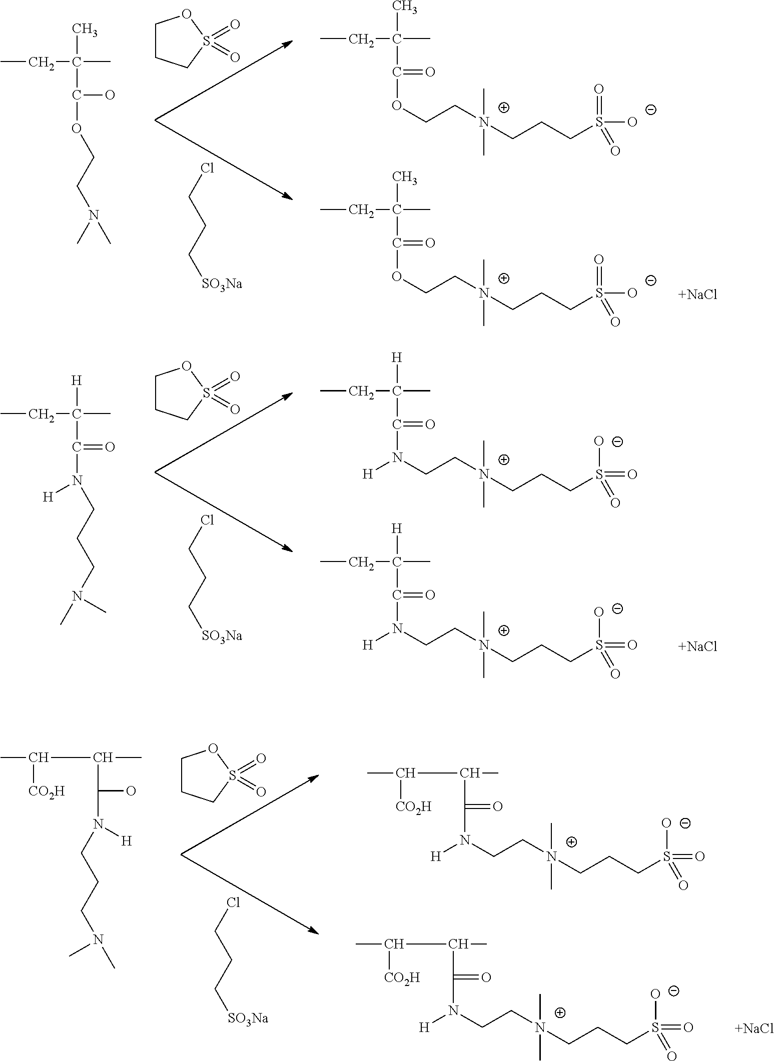

The composition according to the present disclosure may comprise optional ingredients to facilitate application of the composition onto the substrate and/or to provide additional benefits. Optional ingredients include, but are not limited to, crosslinking agents, chelating agents, sequestering or scale-inhibiting agents, degreasing agent, bleaching agents, fillers, bleaching catalysts, pH adjusting agents, viscosity modifiers, co-solvents, antifoaming agents, enzymes, fragrances, colorants, anti-corrosion agents, preservatives, optical brighteners, opacifying or pearlescent agents, and the like.

In the method according to the present disclosure, the composition is applied to the substrate in an amount effective to resist frost. As used herein, the amount effective to resist frost in absolute numbers depends on factors including the frost to be resisted; whether the aim is resistance; the contact time between the copolymer and the surface; other optional ingredients present, and also the surface or aqueous environment in question. In an embodiment, the amount effective to resist frost is such that the copolymer is deposited on the substrate in an amount from 0.0001 to 100 mg/m², typically from 0.01 to 50 mg/m², of the surface applied.

It has been discovered, surprisingly, that the copolymer having repeating units derived from one or more zwitterionic monomers, typically one or more betaine monomers, and repeating units derived from one or more phosphorous acid monomers described herein adsorbs strongly onto metal surfaces, forming the aforementioned disrupted water crystallization on charged surfaces. Accordingly, the substrate, typically in need of resistance of frost is a metal or metal-containing substrate. Typically, the metal is selected from the group consisting of iron, cast iron, copper, brass, aluminum, titanium, carbon steel, stainless steel, and alloys thereof. Preferably, the metal is selected from the group consisting of aluminum and alloys thereof.

Preferably, the substrate is pre-treated before coating to remove impurities and enhance the adhesion of copolymer. For example, an aluminium substrate can be pre-treated by a degreasing agent, which has a concentration from 1% to 10% and pH from 11 to 13 for 30 seconds to 10 mins and then rinsed by water. The aluminium substrate is then dried under proper temperature, such as ambient temperature.

In an embodiment, the method according to the present disclosure comprises the following steps:
(a) Preparing an aqueous solution comprising a copolymer having repeating units derived from one or more zwitterionic monomers and repeating units derived from one or more phosphorous acid monomers;
(b) Immersing a substrate into the aqueous solution prepared by step(a);
(c) Heating the coated substrate at a temperature in the range of 50° C. to 120° C. for 5 to 60 mins.

Preferably, the concentration of the copolymer in aqueous solution is in the range of 3000 to 50000 ppm in step(a).

Preferably, in order to achieve good adhesion of copolymer on the substrate the temperature of the aqueous solution in step(a) and step(b) is in the range of 50° C. to 80° C.

Advantageously, the method can further comprise a mild curing step after step(c) to obtain better anchoring effect. Said mild curing condition can be realized by heating the coated substrate at a temperature in the range of 40° C. to 80° C. for 30 to 180 mins.

The present disclosure also relates to the use of a composition for for making frost resistant a substrate, the composition comprising a copolymer having repeating units derived from one or more zwitterionic monomers, typically one or more betaine monomers, and repeating units derived from one or more phosphorous acid monomers.

The substrate is typically in need of resistance of frost.

The methods and processes, including materials useful therefor, according to the present disclosure are further illustrated by the following non-limiting examples.

### EXAMPLES

### Materials

Degreasing agent KM-CL, from Kexing Chemical

### Example 1: Synthesis of a Statistical Copolymer poly(vinyl phosphonic acid-stat-N-(2-methacryloyloxyethyl)-N,N-dimethyl-N-(3-sulfopropyl)ammoniumbetaine) (poly(VPA-stat-SPE)) in the Present Invention by Conventional Radical Polymerization (Initiator: 2,2′-Azobis(2-methylpropionamidine) dihydrochloride) V50-VPA=20 mol %-SPE=80 mol %)

In a 500 mL kettle reactor equipped with a water condenser and a mechanical agitation, are introduced, at room temperature (22° C.), 10 g of a vinyl phosphonic acid solution (at 85.4% purity), and 61.17 g of distilled water. The mixture was degassed by bubbling nitrogen in the bulk for 50 minutes while the temperature in the solution was increasing up to 60° C. After stabilization of the temperature at 60° C. in the kettle reactor, a 5 wt % V50 aqueous solution (34.3 g, 6.3 mmol) was introduced under a nitrogen blanket. Then, a 40 wt % SPE aqueous solution (220.8 g, 0.79 mol) was continuously fed in two times: 154.58 g for the first 4 hours (flow rate=0.644 g/min) and then 66.25 g during the next 7 hours (flow rate=0.158 g/min). After completion of the feeding, the reaction is let stirring for an additional 2 hours at 60° C.

At the end of the polymerization, a sample was taken for ¹H and ³¹P NMR analysis to determine the SPE and VPA monomer conversions. A sample was also taken for size exclusion chromatography analysis to determine the number average molar mass Mₙ, the weight average molar mass M_{w} and the dispersity.

### Results and Methods:

VPA monomer conversion (³¹P RMN)=89.2%

SPE monomer conversion (¹H RMN)=99.9%

SEC samples were diluted in a mobile phase (1M NH₄NO₃, 100 ppm of NaN₃) and filtered (0.45 μm Millipore) before analyzing.

The samples were analyzed by SEC MALS according to those conditions:
Eluant: 1M NH₄NO₃, 100 ppm of NaN₃ in MilliQ water
Flow rate: 1 mL/min
Columns: Shodex OHpak SB 806M HQ (3*30 cm)
Detection: RI (Agilent detector)+MALLS (MultiAngle Laser Light Scattering) Mini Dawn TREOS
Samples concentration: 5 mg/mL in the mobile phase
Injection volume: 100 μL

$${\overline{M}}_{n ( SEC ‐ MALS )} = 12 kg \cdot {mol}^{- 1} \\ {\overline{M}}_{w ( SEC ‐ MALS )} = 40 kg \cdot {mol}^{- 1} \\ Ð = 3.5$$

### Example 2. Preparation of Aluminum Fins Coated with Poly(VPA-Stat-SPE) Prepared by Example 1

Degreasing agent is diluted with ultrapure water to achieve a final concentration 5% wt solution, which has a pH ˜13. Then aluminum fins are immersed into the 5% wt. solution for 2 to 5 mins and then rinsed by water for another 5 mins. Dry the aluminum fins under ambient temperature.

Heat ultrapure water to 60° C. Dilute the original VPA-SPE solution prepared by Example 1 to 5000 ppm with the heated ultrapure water. Keep the diluted solution warm during the whole coating process.

Cleaned & dried aluminum fins are immersed into the diluted VPA-SPE solution 60° C. for 5 mins.

Place the coated aluminum fins into ovens under 75° C. for 10 mins, under 120° C. for 30 mins and under 80° C. for overnight.

### Example 3. Anti-Frosting Test

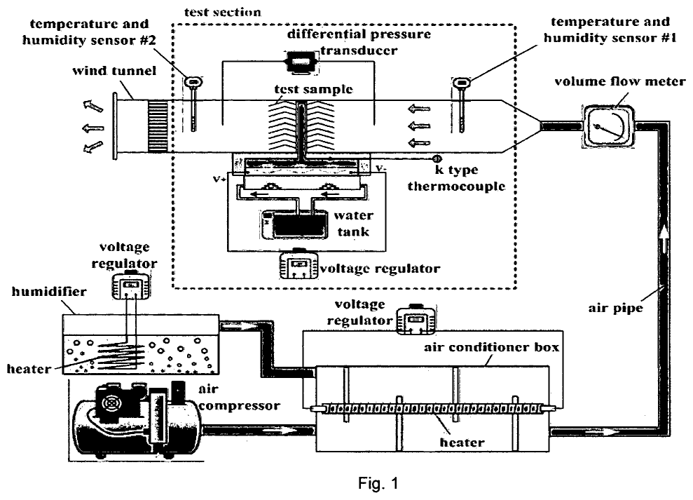

To evaluate the frost-resisting performance, mini heat exchanger (HEX), assembled from aluminum foils, is set up to measure its heat exchange capacity (Q). The facility employed to measure Q is shown in FIG. 1. This rig includes an air compressor, a humidifier, an air conditioner box, a volume flow meter and a transparent test section. The air compressor supplies the air flow, and the humidifier regulates the humidity of the moist air. The moist air temperature in the air conditioner box will be adjusted by the electrical heater regulated by a PID controller. The moist air is ventilated into the wind tunnel and blown over the test sample. The test sample is cooled to subzero degrees Celsius by the semiconductor cooler to set up the frosting condition. The volume flow rate, the temperature, the humidity and the pressure difference of the moist air are measured. Experimental data are acquired by Agilent Data Acquisition Instrument. The data acquisition records the relative humidity and temperature at the entry and exit of the test section, based on which the enthalpy change caused by test sample can be calculated. The heat transfer capacity is represented by heat transfer rate of test sample and is calculated from the enthalpy change. The equations are shown as below.

$${P}_{s} = \frac{2}{15} exp ( 18.59 \; 16 - \frac{3991.11}{T + 233.84} ) \qquad Eq ( 2 )$$

$$d = 0. 622 \frac{ϕ {P}_{s}}{P - ϕ {P}_{s}} \qquad Eq ( 3 )$$

$${h}_{s} = 1.005 T + d ( 2501 + 1.86 T ) \qquad Eq ( 4 )$$

$${\dot{m}}_{i n} = {\dot{m}}_{o u t} = ρ \dot{V} \qquad Eq ( 5 )$$

$$Q = {\dot{m}}_{i n} {h}_{i n} - {\dot{m}}_{o u t} {h}_{o u t} \qquad Eq ( 6 )$$

In the equations, T is the temperature measured in Celsius degrees. Pₛ is the saturated pressure of water vapor in kPa. ϕ is relative humidity. d is moisture content with the unit of kg/kg. hₛ represents the enthalpy of moist air with the unit of kJ/kg. \dot{m}, ρ and \dot{V} are air mass flow rate, air density and air volume flow rate, with unit of kg/h, kg/m³ and m³/h respectively.

The temperature of mini HEX is controlled to be −10° C. by cold water in copper tube. As real air-conditioners will automatically start defrosting when Q decreases to 80% Qmax, the key indicator of the frost-resisting performance in POC is Δt, i.e. the duration time between arriving and leaving 80% of Qmax.

It is shown in Table 1 that the frost-resisting performance of aluminum surface coated by poly(VPA-stat-SPE) prepared by Example 2 is better than blank Al fin when comparing their respective Δt values.

TABLE 1

| Coating nature | Δt(s) |
|---|---|
| Blank Al fin | 636 |
| Example 2 | 966 |
| poly(VPA-sfaf-SPE) | (+52% compared to blank Al fin) |

1-16. (canceled)

17. A method for making a substrate frost resistant, the method comprising applying a composition to a substrate wherein the composition comprises a copolymer having repeating units derived from one or more zwitterionic monomers, typically one or more betaine monomers, and repeating units derived from one or more phosphorous acid monomers.

18. The method according to claim 17, wherein the repeating units derived from one or more zwitterionic monomers are repeating units derived from one or more betaine monomers.

19. The method according to claim 17, wherein the one or more betaine monomers are selected from the group consisting of:
a) alkyl sulfonates or phosphonates of dialkylammonium alkyl acrylates or methacrylates, acrylamide or methacrylamido;
b) heterocyclic betaine monomers;
c) alkyl or hydroxyalkyl sulfonates or phosphonates of dialkylammonium alkyl allylics, typically sulfopropylmethyldiallylammonium betaine;
d) alkyl or hydroxyalkyl sulfonates or phosphonates of dialkylammonium alkyl styrenes;
e) betaines resulting from ethylenically unsaturated anhydrides and dienes;
f) phosphobetaines of formulae 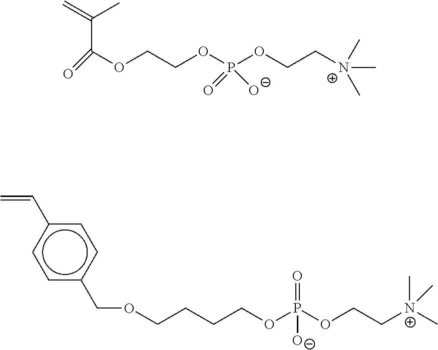
g) betaines resulting from cyclic acetals.

20. The method according to claim 17, wherein the one or more betaine monomers are selected from the group consisting of sulfohydroxypropyldimethylammonioethyl(meth)acrylamide and sulfopropyldimethylammonioethyl(meth)acrylate.

21. The method according to claim 17, wherein the repeating units derived from one or more phosphorous acid monomers are repeating units derived from:
a) phosphoric acid monomers in which at least one of the hydrogen atoms has been replaced with a double bond-containing organic group;
b) phosphonic acid monomers in which at least one of the hydrogen atoms has been replaced with a double bond-containing organic group; and
c) phosphinic acid monomers in which at least one of the hydrogen atoms has been replaced with a double bond-containing organic group.

22. The method according to claim 21, wherein the repeating units derived from one or more phosphorous acid monomers are repeating units derived from vinyl phosphonic acid.

23. The method according to claim 17, wherein the copolymer comprises up to 90 mol % of repeating units derived from phosphorous acid monomers, based on the molar composition of the copolymer.

24. The method according to claim 17, wherein the copolymer comprises greater than 30 mol % of repeating units derived from the one or more zwitterionic monomers, based on the molar composition of the copolymer.

25. The method according to claim 17, wherein the copolymer further comprises repeating units derived from monomers selected from the group consisting of 2-hydroxyethyl methacrylate (HEMA), hydroxypropyl methacrylate, 2-hydroxyethyl acrylate (HEA), hydroxypropyl acrylate, 4-hydroxybutyl acrylate, poly(ethylene glycol) methacrylate (PEGMA), poly(ethylene glycol) methyl ether methacrylate (mPEGMA), poly(ethylene glycol) ethyl ether methacrylate, poly(ethylene glycol) methyl ether acrylate and poly(ethylene glycol) ethyl ether acrylate.

26. The method according to claim 25, wherein the copolymer comprises about 1 mol % to about 20 mol % of repeating units derived from phosphorous acid monomers, based on the molar composition of the copolymer.

27. The method according to claim 25, wherein the copolymer comprises about 80 mol % to about 99 mol % of repeating units derived from the one or more zwitterionic monomers and from the monomers selected from the group consisting of 2-hydroxyethyl methacrylate (HEMA), hydroxypropyl methacrylate, 2-hydroxyethyl acrylate (HEA), hydroxypropyl acrylate, 4-hydroxybutyl acrylate, poly(ethylene glycol) methacrylate (PEGMA), poly(ethylene glycol) methyl ether methacrylate (mPEGMA), poly(ethylene glycol) ethyl ether methacrylate, poly(ethylene glycol) methyl ether acrylate and poly(ethylene glycol) ethyl ether acrylate based on the molar composition of the copolymer.

28. The method according to claim 27, wherein the molar ratio of repeating units derived from the one or more zwitterionic monomers with repeating units derived from the monomers selected from the group consisting of 2-hydroxyethyl methacrylate (HEMA), hydroxypropyl methacrylate, 2-hydroxyethyl acrylate (HEA), hydroxypropyl acrylate, 4-hydroxybutyl acrylate, poly(ethylene glycol) methacrylate (PEGMA), poly(ethylene glycol) methyl ether methacrylate (mPEGMA), poly(ethylene glycol) ethyl ether methacrylate, poly(ethylene glycol) methyl ether acrylate and poly(ethylene glycol) ethyl ether acrylate.

29. The method according to claim 17, wherein the copolymer is a statistical copolymer the weight-average molar mass (Mw) of which is in the range of from about 5,000 to about 3,000,000 g/mol.

30. The method according to claim 17, wherein the copolymer is deposited on the substrate in an amount from 0.0001 to 100 mg/m² of the surface applied.

31. The method of claim 30, wherein the substrate is a metal or metal-containing substrate.

32. The method according to claim 31, wherein the metal is selected from the group consisting of aluminum and alloys thereof.
